(19) United States
(12) Patent Application Publication
(10) Pub. No.: US 2017/0069433 A1
(43) Pub. Date: Mar. 9, 2017

(54) Asymmetric Hybrid Supercapacitor

(71) Applicant: Robert Bosch GmbH, Stuttgart (DE)

(72) Inventors: Frederik Golks, Tuebingen (DE); Pallavi Verma, Leinfelden (DE)

(21) Appl. No.: 15/251,063

(22) Filed: Aug. 30, 2016

(30) Foreign Application Priority Data
Sep. 4, 2015 (DE) 10 2015 216 964.2

(51) Int. Cl. H01G 11/06; H01G 11/68; H01G 11/52; H01G 11/62; H01G 11/36; H01G 11/28; H01G 11/60

(52) U.S. Cl. CPC H01G 11/06; H01G 11/28; H01G 11/68; H01G 11/60; H01G 11/62; H01G 11/36; H01G 11/52

(57) ABSTRACT

An asymmetric hybrid supercapacitor includes a cathode and an anode. The cathode is applied to a first connector, and the anode is applied to a second connector. An electrolyte is present between the cathode and the anode. The anode contains a metal or semimetal. The metal or semimetal has a porosity of at least 20% by volume.

This application claims priority under 35 U.S.C. §119 to patent application number DE 10 2015 216 964.2, filed in Germany on Sep. 4, 2016, the disclosure of which is incorporated herein by reference in its entirety.

### BACKGROUND

The present disclosure relates to an asymmetric hybrid supercapacitor which is characterized by the composition of its anode.

Hybrid supercapacitors (Hybrid Super Capacitors—HSCs), for example lithium ion capacitors, represent a new generation of capacitors, which can provide more power than lithium ion batteries, which although they have a high energy density of more than 100 Wh/kg release this energy only slowly, and which have a higher energy density than high-energy supercapacitors (EDLCs/SCs), which although they can provide more than 100 kW/kg have only a low energy density. Hybrid supercapacitors can, for example, be charged by means of short high-energy pulses that occur in the braking energy recuperation in motor vehicles. The electric energy recovered in this way can then be used in order to accelerate the motor vehicle. This makes it possible to save fuel and to reduce carbon dioxide emissions. Hybrid supercapacitors are also being considered for use as energy sources in electric tools. However, since hybrid supercapacitors represent a new technology compared to other types of supercapacitors and to batteries, only few products which use hybrid supercapacitors are commercially available at present. Lithium ion batteries which have very large dimensions and, owing to their size, are able in each case to provide the power required for the use concerned are mostly used in fields of application which would be suitable for hybrid supercapacitors.

Hybrid supercapacitors can, depending on the cell structure, be divided into two different categories: symmetric and asymmetric hybrid supercapacitors. A symmetric hybrid supercapacitors have an electrode whose material stores energy by means of a reversible Faraday reaction. It can be a hybridized electrode. The second electrode is purely capacitive, i.e. it stores energy by formation of a Helmholz double layer. This structure is customary especially for hybrid supercapacitors of the first generation since it has an electrode configuration which corresponds to the structure of lithium ion battery electrodes or supercapacitor electrodes, so that known electrode production processes can be utilized. Lithium ion capacitors are an example of an asymmetric hybrid supercapacitor. In these, lithiated graphite or another form of lithiatable carbon is used as anode. This allows a maximum voltage window of up to 4.3 V. However, SEI (Solid Electrolyte Interface) formation on the anode is unavoidable when using anode materials having an intercalation potential close to 0 V vs. Li/Li⁺, for example graphite. This is usually countered by targeted cell modification, e.g. by means of electrolyte additives such as vinylene carbonate, in order to stabilize the SEI layer and prevent further electrolyte decomposition. The second type are symmetric hybrid supercapacitors which consist of two internally hybridized electrodes having both Faraday materials and capacitively active materials. This combination enables the power density of the hybrid supercapacitors to be increased appreciably compared to conventional lithium ion batteries or the energy density to be increased appreciably compared to conventional supercapacitors. Furthermore, synergistic effects between the two active electrode materials in the two electrodes can be utilized. In addition, carbon as electrode constituent allows quicker provision of energy at both electrodes since it improves the electrical conductivity of the electrodes. Highly porous carbon can also function as shock absorber for high currents. Symmetric hybrid supercapacitors are superior to asymmetric hybrid supercapacitors in pulsed operation.

The energy density of asymmetric hybrid supercapacitors is normally limited by one electrode consisting of a metal oxide or a conductive polymer which has an intrinsically low capacity. In H. D. Yoo, I. Shterenberg, Y. Gofer, R. E. Doe, C. C. Fischer, G. Ceder, D. Aurbach, Journal of the Electrochemical Society, 161(3) A410-A415 (2014), it is stated that the energy density can be significantly increased by use of magnesium as electrode material. However, charging and discharging of the magnesium foil used proceed slowly and the life of the foil is limited to 4000 cycles.

### SUMMARY

The asymmetric hybrid supercapacitor of the disclosure has an anode which contains a porous metal or semimetal. The porosity of the metal or semimetal is at least 20% by volume and the pore size is, in particular, in the range from 100 nm to 5 μm. This enables the asymmetric hybrid supercapacitor to provide a higher power than conventional asymmetric hybrid supercapacitors since ion diffusion in the anode proceeds predominantly in a liquid medium and is thus significantly accelerated. Owing to the fact that, due to the open structure of the anode, a large metal surface area is available for Faraday reactions, the capacity of the anode is also increased compared to conventional metal anodes. The life of the asymmetric hybrid supercapacitor is increased compared to conventional asymmetric hybrid supercapacitors. This is because volume changes in the anode material, which are due to the intercalation and deintercalation of lithium ions, can proceed more simply because of the open pore structure, so that the anode has a greater mechanical stability than a conventional anode composed of metal foil.

In order to be able to attain the required high porosity, the morphology of the metal or semimetal is preferably selected from the group consisting of porous fibers, nanofibers, hollow nanobodies, hollow porous bodies, open-pored metal foam or semimetal foam, porous metal or semimetal, nanoflowers and combinations thereof.

For the purposes of the present disclosure, porous fibers are fibers, rods or wires which have pores in their outer surface. When the fibers are configured as tubes, the porosity can be generated by the outer wall of the fibers having openings which connect the interior space and the exterior space of the tubes with one another.

For the purposes of the present disclosure, nanofibers are either solid nanofibers or nanotubes. To form a porous structure, the nanofibers form, in one embodiment of the disclosure, a fabric. In this fabric, they do not necessarily have to have a prescribed orientation. In another embodiment, the nanofibers are arranged parallel to one another on a collector onto which the anode is applied. The collector can consist of the same material as the nanofibers or a different material.

The hollow nanobodies can have various geometric shapes. In particular, they are nanospheres. However, other geometric shapes, for example nanocubes, are in principle also possible.

For the purposes of the present disclosure, hollow porous bodies are geometric bodies which in their outer wall have openings which connect the exterior space of the bodies with their interior space. These hollow bodies are, in particular spherical. However, they can in principle also assume other geometric shapes, for example cube shapes.

The open-pored metal foam or semimetal foam can be a metal foam or semimetal foam having conventional porosity or else a metal foam or semimetal foam having wide open porosity. For the purposes of the present disclosure, the term wide open porosity refers to a structure in which the individual pores of the metal foam do not extend from its surface but are accessible from the outside via openings in the walls of other pores.

For the purposes of the present disclosure, a porous metal or semimetal is either unstructured porous material or material whose pore structure has been generated in an ordered manner using a template.

Nanoflowers are metal or semimetal structures which on a microscopic level resemble flowers and trees.

The metal is preferably selected from the group consisting of magnesium, sodium, lithium, aluminum, tin, lead, bismuth and zinc. The semimetal is preferably selected from the group consisting of silicon, antimony and germanium. These metals and semimetals can undergo intercalation and deintercalation reactions with lithium or other suitable alkali metal ions in an advantageous way and can be shaped to give the required porous structure.

To make it possible for the anode not only to undergo Faraday reactions but also to form an electronic double layer (Electronic Double Layer Capacitor, EDLC), the anode preferably additionally contains carbon. The anode particularly preferably contains a plurality of different carbon modifications. This makes it possible to combine carbon materials which give the anode EDLC properties, for example activated carbon or carbon nanofibers, with further carbon materials, which improves the electric contact between the EDLC material and the metal or semimetal and a collector to which the anode is applied. Such materials can be, for example, graphite or carbon black nanoparticles. In order to join the different materials of the anode firmly to one another, preference is also given to the anode containing a binder. The binder can be, in particular, polytetrafluoroethylene (PTFE), polyvinylidene fluoride (PVDF), polyvinylpyrrolidone (PVP), carboxymethylcellulose (CMC) or styrene-butadiene rubber (SBR).

In one embodiment, the anode consists of a mixture of a plurality of the abovementioned constituents which is applied to a collector. Here, the collector can be, in particular, a carbon-coated aluminum collector which makes good electric contact between the aluminum of the collector and the anode material possible. In another embodiment, the anode consists of a self-supporting layer of the anode material.

An electrolyte is arranged between the anode and the cathode of the asymmetric hybrid supercapacitor. To allow good uptake and release of electric charges at the interface between anode and electrolyte, the electrolyte preferably contains an electrolyte salt selected from the group consisting of tetramethylammonium tetrafluoroborate (N(CH₄)₄BF₄), lithium perchlorate (LiClO₄), lithium hexafluorophosphate (LiPF₆), lithium tetrafluoroborate (LiBF₄), lithium bistrifluoromethanesulfonimide ((LiN(SO₂CF₃)₂), lithium bispentafluoroethanesulfonimide (LiN(SO₂C₂F₅)₂), lithium bisfluorosulfonylimide (LiN(SO₂F)₂, LlFSi), lithium bisoxalatoborate (LiB(C₂O₄)₂, LiBOB), lithium oxalyldifluoroborate (LiBF₂(C₂O₄), LiODFB), lithium fluoroalkylphosphate (LiPF₃(CF₃CF₂)₃, LiFAP) and lithium trifluoromethanesulfonate (LiCF₃SO₃). When the metal is selected from the group consisting of magnesium, sodium, lithium and aluminum, the electrolyte salt can also be a salt of the metal.

The electrolyte salt is preferably dissolved in a solvent selected from the group consisting of acetonitrile, dimethyl carbonate, diethyl carbonate, ethyl methyl carbonate, ethylene carbonate, propylene carbonate, ionic liquids and mixtures thereof. The electrolyte salts which are preferred for the asymmetric hybrid supercapacitor are readily soluble in these solvents and the solvents do not undergo any undesirable reactions with the electrode materials.

The solvent can contain a fluoro rubber, for example polyvinylidene fluoride-hexafluoropropylene, suspended therein in order to improve the stability of the electrolyte at high voltages of, in particular, more than 4 V.

### BRIEF DESCRIPTION OF THE DRAWINGS

Illustrative embodiments of the disclosure are depicted in the drawings and explained in more detail in the following description.

FIG. 1 schematically shows an asymmetric hybrid supercapacitor according to one illustrative embodiment of the disclosure.

FIG. 2a shows a porous tubular metal fiber as anode constituent in an illustrative embodiment of the disclosure.

FIG. 2b shows a fabric made up of metal nanofibers as anode constituent in another illustrative embodiment of the disclosure.

FIG. 2c shows metal nanofibers arranged parallel to one another on a collector as anode constituent in yet another illustrative embodiment of the disclosure.

FIG. 2d shows hollow metal nanospheres as anode constituent in yet another illustrative embodiment of the disclosure.

FIG. 2e shows a hollow porous metal sphere as anode constituent in yet another illustrative embodiment of the disclosure.

FIG. 2f shows a metal foam having wide open porosity as anode constituent in yet another illustrative embodiment of the disclosure.

FIG. 2g shows an open-pored metal foam as anode constituent in yet another illustrative embodiment of the disclosure.

FIG. 2h shows a porous metal as anode constituent in yet another illustrative embodiment of the disclosure.

FIG. 2i shows a porous metal produced by means of a template as anode constituent in yet another illustrative embodiment of the disclosure.

FIG. 2j shows a porous metal which has been produced by means of a template and has a parallel arrangement of metal rods as anode constituent in yet another illustrative embodiment of the disclosure.

FIG. 2k shows a nanoflower composed of metal as anode constituent in yet another illustrative embodiment of the disclosure.

### DETAILED DESCRIPTION

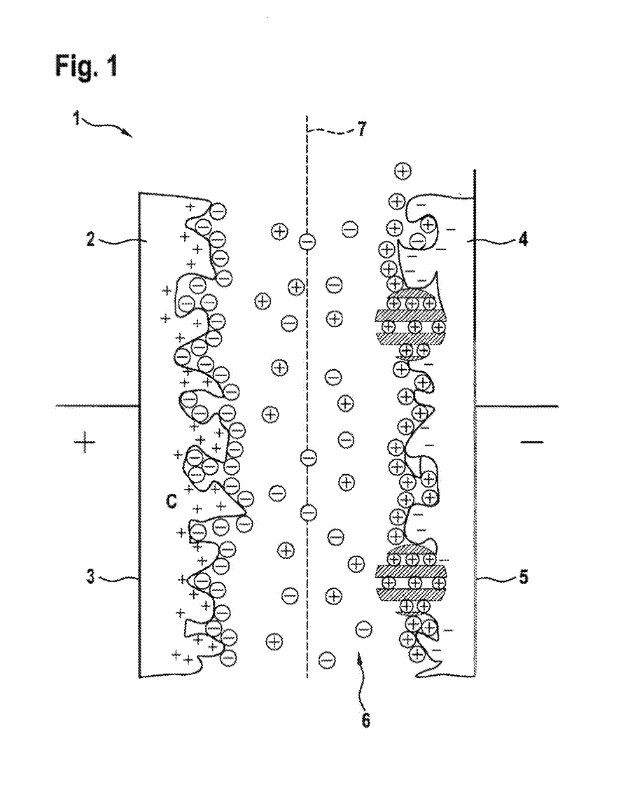

An asymmetric hybrid supercapacitor 1 according to the illustrative embodiments of the disclosure described below has the structure depicted in FIG. 1. A cathode 2 which consists of activated carbon has been applied to a first collector 3. An anode 4 has been applied to a second collector 5. The two collectors 3, 5 each consist of carbon-coated aluminum. An electrolyte 6 is present between the cathode 2 and the anode 4. A separator 7 separates the cathode 2 from the anode 4. Embedding of Li⁺ ions into the anode 4 is shown schematically in two magnifications in FIG. 1.

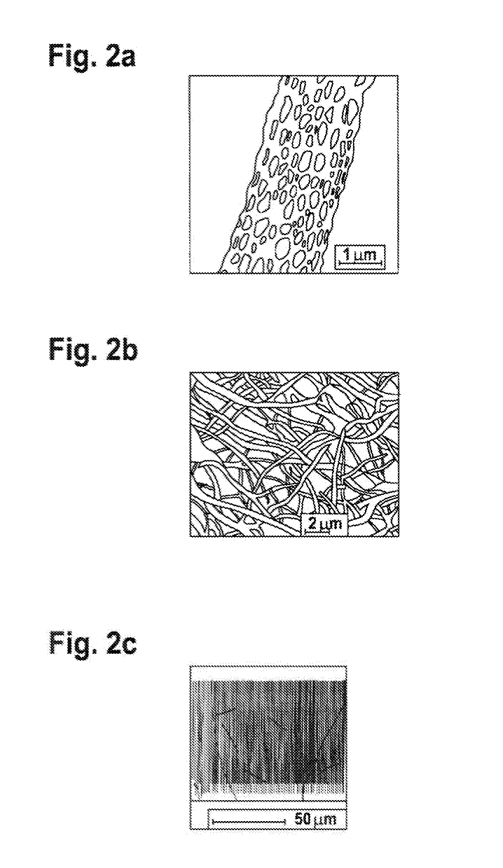

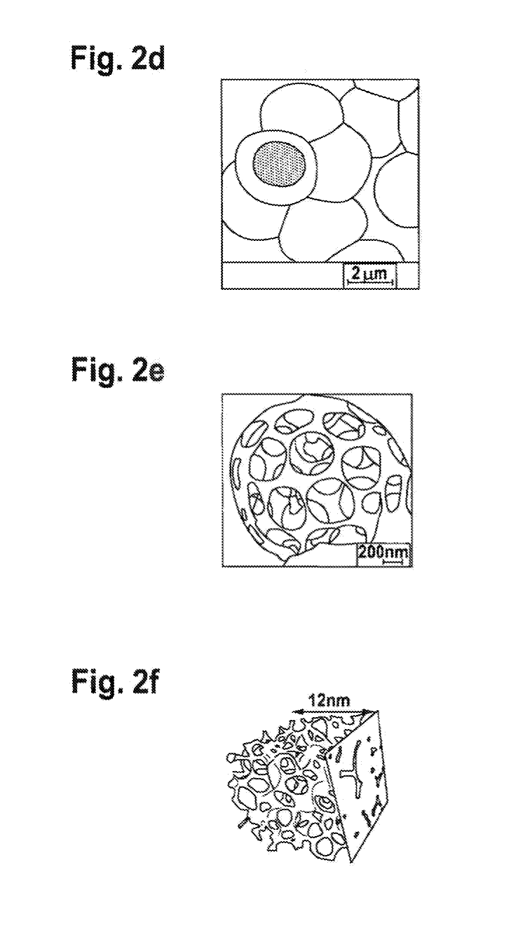

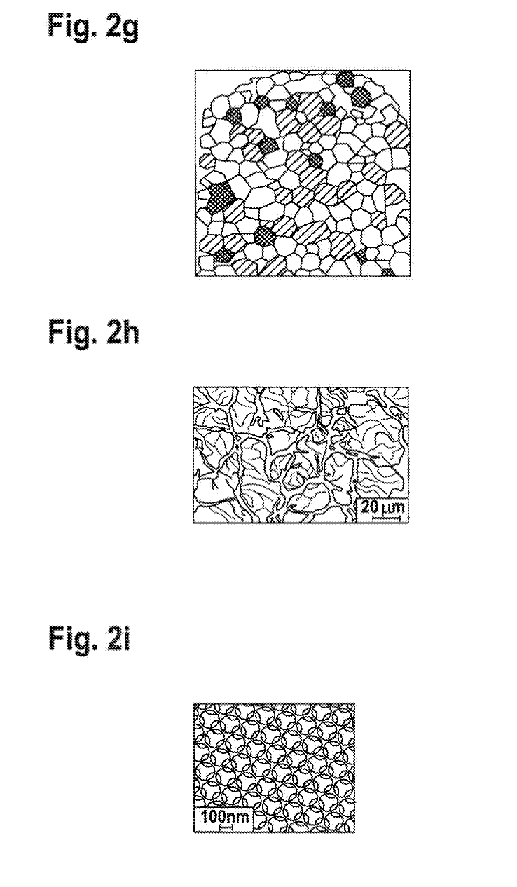

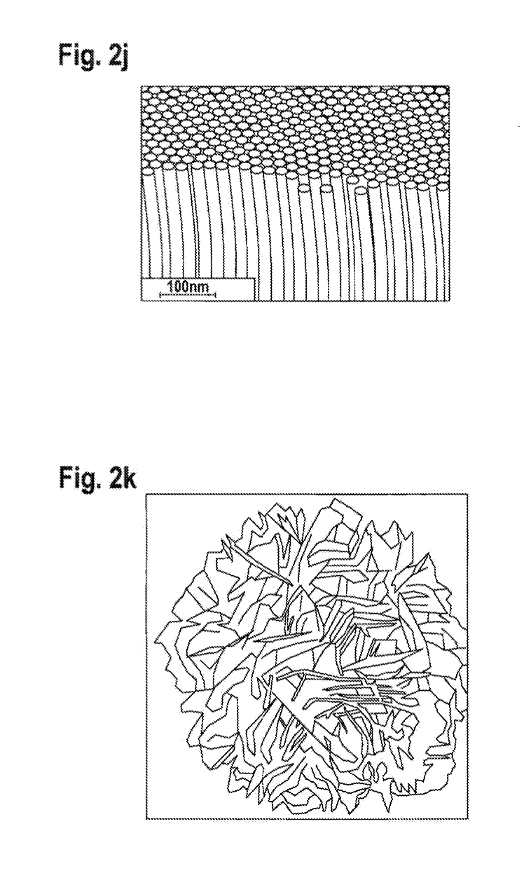

The anode 4 in each case consists of an anode material which contains a metal or semimetal, activated carbon as EDLC material, graphite and the binder PTFE. In a first illustrative embodiment of the disclosure, the metal or semimetal has the shape of hollow rod-like fibers having porous outer walls. Such a fiber is depicted in FIG. 2a. It has a diameter of 2 μm. In a second illustrative embodiment, the metal or semimetal forms a disordered fabric of nanofibers having a diameter of about 700 nm, as shown in FIG. 2b. In a third illustrative embodiment, these nanofibers are applied parallel to one another to the surface of the second collector 5. This is shown in FIG. 2c. In a fourth illustrative embodiment, the metal or semimetal has the shape of nanospheres having diameters of from at least 100 nm to less than 2 μm, as shown in FIG. 2d. In a fifth illustrative embodiment, the metal or semimetal forms spheres which have a diameter of about 2 μm and whose outer walls have openings which make the interior space of these spheres accessible. Such a sphere is depicted in FIG. 2e. In a sixth illustrative embodiment, the metal or semimetal is a metal foam having the wide open pore structure depicted in FIG. 2f. In a seventh illustrative embodiment, the metal or semimetal is an open-pore metal foam having the pore structure depicted in FIG. 2g. In an eighth illustrative embodiment, the metal or semimetal is a porous metal having the pore structure shown in FIG. 2h. The pores of the metal foams and of the porous metal have diameters in the range from 100 nm to 5 μm. In a ninth illustrative embodiment, the metal or semimetal is a porous metal produced by means of a template. As shown in FIG. 2i, this has regularly arranged pores having a diameter of 100 μm. In a tenth illustrative embodiment, the metal or semimetal has a porous structure which has been produced by means of another template. As a result, it has the parallel metal rods depicted in FIG. 2j. In an eleventh illustrative embodiment, the metal or semimetal consists of metal leaves which have a size of 50-100 nm and together give the shape of the 1-5 μm nanoflower depicted in FIG. 2k. The metals or semimetals of the first to eleventh illustrative embodiments of the disclosure each have a porosity of at least 20% by volume. This porosity can be determined from a BET isotherm.

In the illustrative embodiments B1 to B5, the metal or semimetal is one of the metals shown in table 1, and in the illustrative embodiments B6 to B8, it is one of the semimetals shown in table 1. The table in each case indicates the redox reactions proceeding at the anode 4 and also the capacitor C of the anode. The metals and semimetals as per the illustrative embodiments B1 to B8 can, for example, be used in combination with an electrolyte 6 which contains 1 mol/l of lithium perchlorate as electrolyte salt 1 in the solvent acetonitrile. The separator 7 consists of an aramid fabric.

TABLE 1

| | | | C | Electrolyte | |
|---|---|---|---|---|---|
| # | M | Redox reaction | [mAh/g] | salt | Solvent |
| B1 | Sn | Si + x Li⁺ + x e⁻ -> | 960 | LiClO₄ | Acetonitrile |
| | | LiₓSi | | | |
| B2 | Pb | Pb + x Li⁺ + x e⁻ -> | 550 | LiClO₄ | Acetonitrile |
| | | LiₓPb | | | |
| B3 | Bi | Bi + x Li⁺ + x e⁻ -> | 385 | LiClO₄ | Acetonitrile |
| | | LiₓBi | | | |
| B4 | Ge | Ge + x Li⁺ + x e⁻ -> | 1384 | LiClO₄ | Acetonitrile |
| | | LiₓGe | | | |
| B5 | Li | Li -> Li⁺ + e⁻ | 3861 | LiClO₄ | Acetonitrile |
| B6 | Si | Si + 4.4 Li⁺ + 4.4 e⁻ -> | 3579 | LiClO₄ | Acetonitrile |
| | | Li_{4.4}Si | | | |
| B7 | Sb | Sb + x Li⁺ + x e⁻ -> | 660 | LiClO₄ | Acetonitrile |
| | | LiₓSb | | | |
| B8 | Ge | Ge + x Li⁺ + x e⁻ -> | 1384 | LiClO₄ | Acetonitrile |
| | | LiₓGe | | | |

In illustrative embodiments B9 to B15, one of the metals aluminum, magnesium or sodium is used as constituent of the anode 4. The capacitor C of the resulting anode 4 and combinations of electrolyte salt and solvent in different illustrative embodiments are shown in table 2. Here, the concentration of the electrolyte salt in the solvent is in each case 1 mol/l. It has been found that when aluminum is used as anode material, it is possible not only to use the electrolyte 6 used in illustrative embodiments B1 to B8 but also to use a solution of aluminum (III) chloride in the ionic liquid 1-butyl-3-methylimidazolium hexafluorophosphate (BMIM PF6). When magnesium is used as electrode material, it is possible not only to use the electrolyte 6 used in illustrative embodiments B1 to B8 but also to use a solution of magnesium perchlorate in propylene carbonate as electrolyte 6, with polyvinylidene fluoride hexafluoropropylene (PVdF(HFP)) being added to the propylene carbonate. It is also possible to use a mixture of the electrolyte salts Mg₂Cl₃ and Mg[Ph₂AlCl₂]₂ in acetonitrile, as is known from the publication by H. D. Yoo et al. Suitable electrolytes which can be used together with a sodium electrode are, for example, a solution of sodium perchlorate in propylene carbonate or a solution of sodium hexafluorophosphate in a mixture of ethylene carbonate and dimethyl carbonate.

TABLE 2

| | | | C | | |
|---|---|---|---|---|---|
| | | | [mAh/ | Electrolyte | |
| # | M | Redox reaction | g] | salt | Solvent |
| B9 | Al | Al + 3 Li⁺ + 3 e⁻ -> | 993 | LiClO₄ | Acetonitrile |
| | | Li₃Al | | | |
| B10 | Al | Al -> Al³⁺ + 3 e⁻ | 993 | AlCl³ | BMIM PF6 |
| B11 | Mg | Mg + x Li⁺ + x | 195 | LiClO₄ | Acetonitrile |
| | | e⁻ -> LiₓMg | | | |
| B12 | Mg | Mg -> Mg²⁺ + 2 e⁻ | 195 | Mg(ClO₄)₂ | Propylene |
| | | | | | carbonate + |
| | | | | | PVdF(HFP) |
| B13 | Mg | Mg -> Mg²⁺ + 2 e⁻ | 195 | Mg₂Cl₃ + | Acetonitrile |
| | | | | Mg[Ph₂AlCl₂]₂ | |
| B14 | Na | Na -> Na⁺ + e⁻ | | NaClO₄ | Propylene |
| | | | | | carbonate |
| B15 | Na | Na -> Na⁺ + e⁻ | | NaPF₆ | Ethylene |
| | | | | | carbonate + |
| | | | | | dimethyl |
| | | | | | carbonate |

All the electrolytes indicated allow Faraday reactions of the metal or semimetal in addition to electric double layer charging of the carbon present in the anode. The high porosity of the metal or semimetal ensures that a high surface area is available for the Faraday reactions.

What is claimed is:

1. An asymmetric hybrid supercapacitor, comprising:
a cathode; and
an anode containing a metal or semimetal having a porosity of at least 20% by volume.

2. The asymmetric hybrid supercapacitor according to claim 1, wherein a morphology of the metal is selected from the group consisting of porous fibers, nanofibers, hollow nanobodies, hollow porous bodies, open-pored metal foam, porous metal, nanoflowers, and combinations thereof.

3. The asymmetric hybrid supercapacitor according to claim 2, wherein the nanofibers form a fabric.

4. The asymmetric hybrid supercapacitor according to claim 2, wherein the hollow nanobodies and the hollow porous bodies are spheres.

5. The asymmetric hybrid supercapacitor according to claim 1, wherein:
the metal is selected from the group consisting of magnesium, sodium, lithium, aluminum, tin, lead, bismuth, and zinc; and
the semimetal is selected from the group consisting of silicon, antimony, and germanium.

6. The asymmetric hybrid supercapacitor according to claim 1, wherein the anode additionally contains carbon.

7. The asymmetric hybrid supercapacitor according to claim 6, wherein the anode contains a plurality of different carbon modifications.

8. The asymmetric hybrid supercapacitor according to claim 1, further comprising:
an electrolyte containing at least one electrolyte salt; and
the at least one electrolyte salt is selected from the group consisting of tetramethylammonium tetrafluoroborate, lithium perchlorate, lithium hexafluorophosphate, lithium tetrafluoroborate, lithium bistrifluoromethanesulfonimide, lithium bispentafluoroethanesulfonimide, lithium bisfluorosulfonylimide, lithium bisoxalatoborate, lithium oxalyldifluoroborate, lithium fluoroalkylphosphate, and lithium trifluoromethanesulfonate.

9. The asymmetric hybrid supercapacitor according to claim 1, wherein:
the metal is selected from the group consisting of magnesium, sodium, lithium, and aluminum; and
the asymmetric hybrid supercapacitor has an electrolyte containing at least one electrolyte salt which is a salt of the metal.

10. The asymmetric hybrid supercapacitor according to claim 8, wherein:
the electrolyte salt is dissolved in a solvent; and
the solvent is selected from the group consisting of acetonitrile, dimethyl carbonate, diethyl carbonate, ethyl methyl carbonate, ethylene carbonate, propylene carbonate, ionic liquids, and mixtures thereof.

11. The asymmetric hybrid supercapacitor according to claim 9, wherein:
the electrolyte salt is dissolved in a solvent; and
the solvent is selected from the group consisting of acetonitrile, dimethyl carbonate, diethyl carbonate, ethyl methyl carbonate, ethylene carbonate, propylene carbonate, ionic liquids, and mixtures thereof.

12. The asymmetric hybrid supercapacitor according to claim 2, wherein the nanofibers are arranged in parallel on a collector to which the anode is applied.
